(19) United States
(12) Patent Application Publication
(10) Pub. No.: US 2007/0010919 A1
(43) Pub. Date: Jan. 11, 2007

(54) Tilt regulation device and method for regulating vehicle tilt

(75) Inventor: Dieter Ammon, Remseck (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/558,268

(22) PCT Filed: Apr. 23, 2004
(86) PCT No.: PCT/EP04/04300

§ 371 Date: Nov. 28, 2005

(30) Foreign Application Priority Data
May 28, 2003 (DE) 103 24 278.3

(51) Int. Cl. G06F 17/00

(52) U.S. Cl. 701/1; 340/429; 340/440

(57) ABSTRACT

The invention relates to a tilt regulating device (16) for a vehicle (10), with detecting means (20) for detecting a roll velocity signal (\dot{κ}), representing the roll velocity of the vehicle (10), and for detecting a set steering angle signal (δ_{L}^{SET}), with regulating means (21, 29, 30) for generating a steering signal (δ_{L}) on the basis of the roll velocity signal (\dot{κ}) and the set steering angle signal (δ_{L}^{set}), and with output means (31) for outputting the steering signal (δ_{L}) to a steering actuator (15) for steering one or more wheels (11) of at least one axle of the vehicle (10). It is proposed that tilt regulating device (16) activates the steering actuator (15) by means of the steering signal (δ_{L}) in such a way that, at least for a certain time, the vehicle (10) is kept in a single-track driving mode.

The invention relates to a tilt regulating device for a vehicle, with detecting means for detecting a roll velocity signal, representing the roll velocity of the vehicle, and for detecting a set steering angle signal, with regulating means for generating a steering signal on the basis of the roll velocity signal and the set steering angle signal, and with output means for outputting the steering signal to a steering actuator for steering one or more wheels of at least one axle of the vehicle. The invention also relates to a vehicle, in particular a multi-track vehicle, with a tilt regulating device of this type and also relates to a method functioning in the manner of the tilt regulating device.

A tilt regulating device of this type is known for example from German Offenlegungsschrift DE 40 32 317 A1. The tilt regulation described there damps the rolling motions of vehicles with four-wheel steering and of vehicles with front steering. The known tilt regulating device is based on the rolling dynamics of the vehicle body, taking into account signals which indirectly or directly present the roll angular velocity. Moreover, the driver's desire for the direction of travel, that is the set steering angle, is taken into account.

Improved stability behavior is brought about by supplementary steering according to German Offenlegungsschrift DE 33 00 640 A1, in which the traveling speed, the yaw angular velocity, the lateral acceleration, the longitudinal acceleration, the steering wheel turning angle, that is the set steering angle, condition of the tyres or the like are taken into account. The rolling behavior of a vehicle is still not taken into account.

In the case of the regulating device according to WO 99/01320, there are two regulating sub-devices, which are independent of each other and intervene in the steering of a vehicle and/or in the chassis actuators of the vehicle. The regulating device is based for example on wheel speed signals, yawing rate signals, lateral acceleration signals and steering angle signals.

Improved emergency rolling behavior in the event of failure of a lateral acceleration sensor or a yawing rate sensor, for example, is offered by a vehicle steering system according to German Offenlegungsschrift DE 44 22 031. In such a situation where damage is incurred, an assisting steering torque is reduced, so that it is still possible for the steering system to be operated as optimally as possible even in the event of damage.

The devices known from the prior art are aimed at keeping a motor vehicle, here specifically automobiles, in a stable driving mode on four wheels. In the case of single-track vehicles, for example motorcycles or the like, they are however specifically to be kept in a balanced tipping state. Furthermore, multi-track vehicles can also tilt, so that, at least for a certain time, they are operated in a single-track driving mode. Operating states of this kind are known for example from films and artistic presentations.

It is therefore the object of the present invention to provide an optimized tilt regulation for single-track vehicles or for multi-track vehicles in single-track driving mode.

This object is achieved in the case of the tilt regulating device of the type mentioned at the beginning by it activating the steering actuator by means of the steering signal in such a way that, at least for a certain time, the vehicle is kept in a single-track driving mode.

The steering signal generated by the tilt regulating device provides a stable single-track driving mode of the vehicle, which behaves as though a fictitious third wheel were present. Any mistaken steering interventions by the driver are corrected by the tilt regulating device. A multi-track vehicle that inadvertently goes onto two wheels can also, at least for a certain time, be kept in a single-track driving mode, and consequently stabilized again, before it is expediently subsequently operated in multi-track driving mode again.

The tilt regulating device may be a separate structural unit or, for example, integrated in a stability control system of the vehicle. It may take the form of hardware and/or software, for example it may be contained in program code which can be executed by a control means, for example a microprocessor.

Advantageous refinements of the invention are provided by the dependent claims and the description.

When a change of direction of the vehicle into a first direction is prescribed by the set steering angle signal, the regulating means expediently activate the steering actuator in a second direction, counter to the first direction, if this is required for regulating purposes. For example, a change of direction is first initiated by a countersteering movement. Then, the tilt regulating device changes the direction of the set steering angle and sets a greater steering angle than is prescribed by the set steering angle. At the end of the change of direction, the steering signal converges in the direction of the set steering angle signal to form a steady-state target value.

Detecting means for detecting one or more of the signals mentioned below are expediently formed. In a corresponding way, the regulating means advantageously evaluate these signals in the formation of the steering signal:
a yaw angular velocity signal, representing the yaw angular velocity of the vehicle,
a velocity signal, representing the velocity of the vehicle,
a roll angle signal, representing the roll angle of the vehicle,
a tire aligning torque signal, representing the tire aligning torque of the vehicle,
a lateral acceleration signal, representing the lateral acceleration of the vehicle,
a longitudinal acceleration signal, representing the longitudinal acceleration of the vehicle,
a lateral velocity signal, representing the lateral velocity of the vehicle, and/or
a sideslip angle signal, representing the sideslip angle of the vehicle.

It goes without saying that one or more of the aforementioned signals are advantageously detected and evaluated by the tilt regulating device.

A particularly advantageous regulating concept of the tilt regulating device according to the invention is based on a model formulation in which the behavior of the vehicle can be described by means of six state variables, which are combined to form a state vector \vec{z}^{T}.
\vec{z}^{T}=└\dot{ψ}υ_{q}κ\dot{κ}F_{q}^{υ}F_{q}^{h}┘ (1)
where \dot{ψ} is the yaw (angular) velocity, υ_{q} is the lateral velocity, κ is the roll angle, \dot{κ} is the roll velocity, F_{q}^{v} and F_{q}^{h} are the lateral tire forces on the front wheel and rear wheel of the vehicle, which can be determined from the aforementioned variables. Altogether, the dynamic behavior of the vehicle can consequently be described by a nonlinear state model of the sixth order:
\dot{\vec{z}}=\vec{f}(\vec{z},δ₁,\dot{δ}₁,Fₛ) (2)
where δ_{L} is the steering angle set on the vehicle (the index ‘L’ always refers hereafter to the steering of the vehicle) and Fₛ is a lateral force acting on the vehicle. In steady operating states B, i.e. when the state variables do not change over time, the following applies:
\vec{f}(\vec{z}^{B},δ₁,\dot{δ}₁=0,Fₛ=0)≡0; \vec{z}^{B}=:\vec{g}_{B}(δ_{L}), (3)
so the individual state variables are in a relationship g_{B} with the set steering angle δ_{L}. Therefore, the following relation is obtained, for example, between the roll angle κ and the yaw velocity \dot{ψ}:

$$ψ = - \frac{g}{ν} \frac{{1}_{w} sin κ}{{h}_{w} + {1}_{w} cos κ} . , \qquad ( 4 )$$

where h_{W} is the height of the kinematic rolling pole and l_{w} the centroid distance of the kinematic rolling pole in the longitudinal direction. If it is then assumed that the system dynamics in the vicinity of the respective operating point B are substantially constant, a linearized state model can be derived by approximation on the basis of the formula (2):
\dot{\vec{z}}=\vec{f}(\vec{z},δ_{L}, \dot{δ}_{L},Fₛ)≈A(\vec{z}−\vec{z}^{B})+\vec{d}₁(δ_{L}−δ_{L}^{B})++\vec{d}₂\dot{δ}_{L}\vec{e}Fₛ. (5)
The system matrix A and the reference vectors d₁, d₂ and the disturbance vector \vec{e} are obtained directly from the system transfer function \vec{f}:

$$A = \frac{\partial {f}^{->}}{\partial {z}^{->}} {\vert}_{{z}^{->} = {{z}^{->}}^{B}} ; {{d}^{->}}_{1} = \frac{\partial {f}^{->}}{\partial {δ}_{L}} {\vert}_{{z}^{->} = {{z}^{->}}^{B}} ; {{d}^{->}}_{2} = \frac{\partial {f}^{->}}{\partial {\dot{δ}}_{L}} {\vert}_{{z}^{->} = {{z}^{->}}^{B}} ; \\ e = \frac{\partial {f}^{->}}{\partial {F}_{s}} {\vert}_{{z}^{->} = {{z}^{->}}^{B}} . \qquad ( 14 )$$

On this basis, it is first possible formally to introduce a state feedback \vec{k} for the stabilization of the system, with δ_{L}^{set} as the set steering angle prescribed by the driver:
δ_{L}=\vec{k}^{T}(\vec{z}−\vec{z}^{B})+δ_{L}^{set}; with \vec{z}^{B}=:\vec{g}_{B}(δ_{L}^{set}). (6)
as a state of equilibrium or target state. In this case, \vec{k}^{T}(\vec{z}−\vec{z}^{B}) is a stabilization component determined by the tilt regulation and δ_{L}^{set} is the default component. The overall system dynamics therefore become:
(E−\vec{d}₂\vec{k}^{T})\vec{\dot{z}}=(A+\vec{d}₁\vec{k}^{T})(\vec{z}−\vec{z}^{B})−\vec{d}₁\vec{k}^{T}\vec{z}^{B}+\vec{d}₁(δ^{set}−δ_{L}^{B})+(1+\vec{k}^{T}\vec{g}′_{B})\vec{d}₂δ^{set}+\vec{e}Fₛ. (7)

The stabilization formulation (6) takes directly as the operating or development point B the target state \vec{z}^{B}=:\vec{g}_{B}(δ_{L}^{set}) of the overall system that is aimed for via δ_{L}^{set}. Consequently, all the relevant nonlinearities are correctly registered.

The feedback parameters in the stabilization vector \vec{κ} must then be determined in such a way that a stable operating state is always achieved in finite time. Decisive for this are the eigenvalues of the closed control loop (7). Its system matrix A* is obtained as:
A*=(E−\vec{d}₂\vec{k}^{T})⁻¹(A+\vec{d}₁\vec{k}^{T}), (8)

The eigenvalues λᵢ, i=1 . . . n can consequently be determined from
Det·└λE−A*┘=0 (9)

In the case of the requirement for stable eigenvalues, i.e. negative real eigenvalues, which have a predetermined minimum damping Dmin and, moreover, do not go below an eigenfrequency fₑ^{set}, feedback parameters kᵢ (i=1 . . . n) can be unequivocally determined by means of optimization on the basis of the formulas (8) and (9). Preferably, the nonlinearities of the overall system are taken into account by determining a suitable stabilization configuration not only for the operating point B but also for the greatest possible area around B.

Segmentation is expediently carried out respectively into 3-6 traveling velocity-specific solutions and, if appropriate, into 3-6 longitudinal acceleration-optimized solutions, between which it is possible in each case to switch over or interpolate. As an alternative to this, it is of course also possible for a nonlinear controller design to be directly devised on the basis of the presented model and synthesis concept.

The regulating means are expediently designed for generating a steering reaction signal and the output means are expediently designed for outputting the signal to a steering reaction actuator, with which a steering reaction torque can be generated for the driver of the vehicle at a manual steering means of the vehicle, for example as a steering wheel or at a steering fork. In this way, the driver receives feedback with respect to his steering actions.

The following expedient refinements of the invention relate in particular to a multi-track vehicle which is, for a certain time, kept in a single-track driving mode by the tilt regulation according to the invention. Usually, multi-track vehicles are operated for as long as possible in such a way that all wheels are in contact with the roadway. However, driving situations in which the vehicle tilts may arise. By contrast with known regulating systems, however, the tilt regulating device according to the invention expediently determines a tilting state required for the stabilization of the vehicle, in which the vehicle is in the single-track vehicle driving mode. The vehicle is operated in this tilting state or single-track driving mode until it is stabilized. For example, a change of direction is carried out in the single-track driving mode. Only after the change of direction is the vehicle returned to such a driving state that all its wheels are in contact with the roadway.

The regulating means expediently keep the multi-track vehicle in the tilting state until after the determination of an end of tilting signal. The end of tilting signal may be determined by the tilt regulating device itself. However, it is also possible for a dynamic control system of the vehicle to send the tilt regulating device according to the invention a corresponding end of tilting signal.

The regulating means expediently includes a state observer.

In the case of a single-track or multi-track vehicle designed according to the invention, there are expediently sensors for generating the roll velocity signal and for determining the set angle signal and also, if appropriate, for further signals of those previously mentioned. The vehicle also includes a steering actuator, which can be activated by the tilt regulating device. In the case of the vehicle according to the invention, there is advantageously also a steering reaction actuator for generating a steering reaction signal.

A manual steering means, at which the set steering angle signal is determined, expediently only acts on the steerable wheels of the vehicle via the steering actuator or actuators. It goes without saying that the tilt regulating device according to the invention may also be designed for multi-axle steering.

The invention is explained in more detail below on the basis of an exemplary embodiment with reference to the drawing, in which:

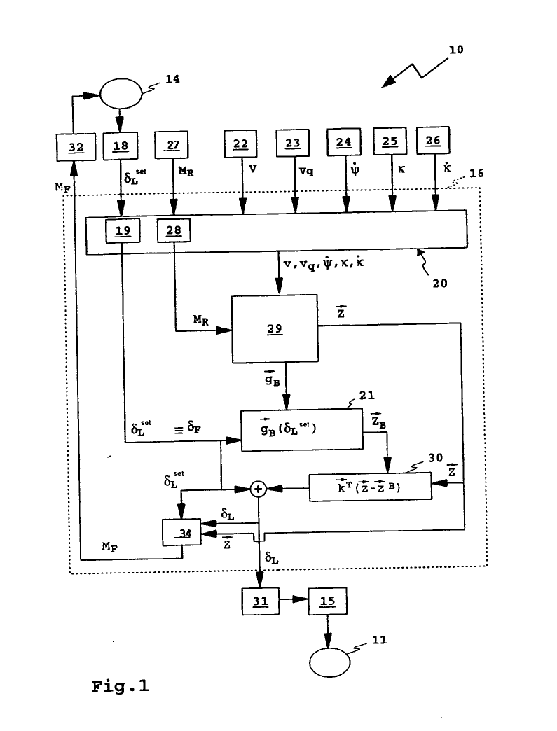

FIG. 1 shows a vehicle according to the invention, represented partly in a greatly schematized form, with a tilt regulating device according to the invention,

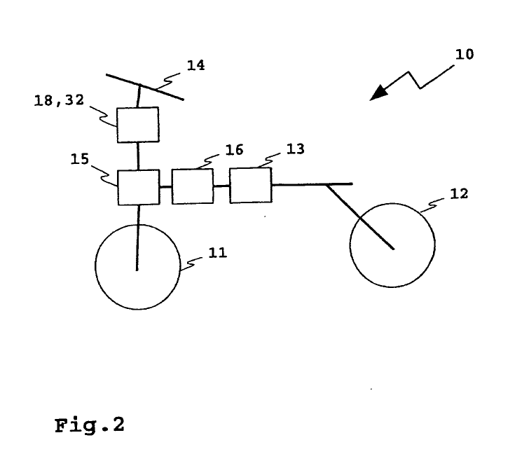

FIG. 2 shows a single-track vehicle according to the invention, represented in a schematized form,

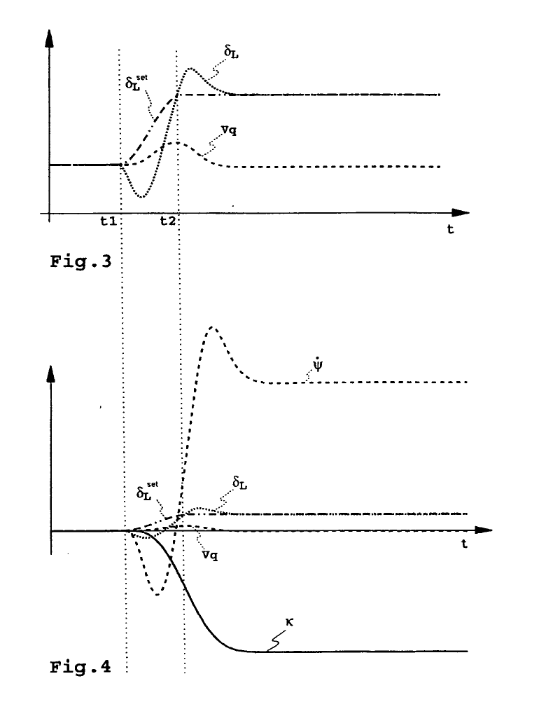

FIG. 3 shows steering angle and lateral velocity curves of a tilt regulating device according to FIG. 1, and

FIG. 4 shows yaw velocity and roll angle curves and the action of a tilt regulating device according to FIG. 1.

A vehicle 10 shown in FIGS. 1 and 2, for example a motorcycle or an automobile, has one or more steerable wheels 11, for example front wheels, and also non-steerable wheels 12, which are for example the rear wheel or wheels of the vehicle 10 and are driven by an engine 13. By means of a steering wheel 14, a handlebar or some other manual steering means, the wheels 11 can be steered. However, the steering intervention does not take place directly, but by means of a steering actuator 15, which is activated by a tilt regulating device 16.

Actuation of the steering wheel 14 of the vehicle 10 is sensed by a steering angle sensor 18. The steering angle sensor 18 sends a set steering angle signal δ_{L}^{SET} to the device 16. An input 19 of detecting means 20 of the device 16 detects the set steering angle signal δ_{L}^{SET} and transmits it to a regulating module 21.

Driving state sensors 22 to 26 transmit to the detecting means 20, which are, for example, one or more interface microprocessors for the detection of digital and/or analog signals, a (longitudinal) velocity signal V, a lateral velocity signal Vq, a yaw velocity signal \dot{+ψ}, a roll angle signal κ and also a roll velocity signal \dot{κ}. These signals and an aligning torque signal M_{R}, which is sensed by a tire aligning torque sensor 27 and is present at an input 28 of the detecting means 20, are transmitted to a driving state observer 29.

The driving state observer 29 determines a steady-state operating point g_{B} and a state vector Z, for example according to the aforementioned formulas (1) and (3). The driving state observer 29 transmits the steady-state operating point g_{B} to the regulating module 21. The regulating module 21 determines a steady state Z_{B} of the state vector Z, according for example to the formula (3), and transmits this to a regulating module 30.

On the basis of the state vectors Z and Z_{B}, the regulating module 30 calculates the stabilization component K (Z−Z_{B}), for example according to the formula (6). This stabilization component is added to the default component δ_{L}^{SET}, so that altogether the steering signal δ_{L} (see formula (6)) is formed. The steering signal δ_{L} is output by output means 31, which can for example output digital and/or analog voltage signals, to the steering actuator 15, which controls the steerable wheel or wheels 11 according to the steering signal δ_{L}.

A driver of the vehicle 10 receives feedback on his operating actions through a steering reaction actuator 32, for example a servomotor, which acts on the steering wheel 14. A driver steering torque regulating system 34 controls the steering reaction actuator 32 by a steering reaction signal M_{F}. Input variables of the steering torque regulating system 34 are the set steering angle δ_{L}^{SET}, the steering signal δ_{L} and the state vector Z.

The device 16 is preferably configured as a microprocessor regulating system, in which, for example, the modules 21, 29, 30 and 32 take the form of software, for example in the form of software functions or program modules. The program code of the program modules is executed by a microprocessor, which is not represented in the figure, and is stored for example in a storage means, for example a flash memory.

The advantageous operating mode of the device 16 according to the invention can be seen from the diagrams in FIGS. 3 and 4.

At a point in time t1, a change of direction is initiated at the steering wheel 14, the set steering angle signal δ_{L}^{SET}, depicted by dashed-dotted lines, rising until it reaches a steady-state value at a point in time t2. The device 16 generates the steering signal δ_{L}, depicted by the dotted line, which, after the point in time t1, first follows a curve counter to the set steering angle δ_{L}^{SET}, then rises faster than the default curve δ_{L}^{SET} and, after an overshoot, which begins at the point in time t2, settles at the steady-state target value, which coincides with the signal δ_{L}^{SET}. During the steering between the points in time t1 and t2, a positive lateral velocity V_{q} results from the rolling motion of the vehicle 10.

FIG. 4 contains the signals shown in FIG. 3 and additionally the yaw velocity and the roll angle curves of the vehicle 10 when there is a change of direction according to FIG. 3. However, the scaling has been changed in comparison with FIG. 3, in order that the relation of the roll angle κ (depicted by a solid line) to the steering angle signals δ_{L} and δ_{L}^{SET} is represented correctly. All the angle signals are for example given in degrees. It is evident from FIG. 4 that the target roll angle κ_{target}, of for example 20 degrees, is reached by the device 16 within a short time, of for example half a second. The stabilization model of the device 16 is consequently suitable for driving maneuvers in extreme ranges.

1. A tilt regulating device for a vehicle (10), with detecting means (20) for detecting a roll velocity signal (\dot{κ}), representing the roll velocity of the vehicle (10), and for detecting a set steering angle signal (δ_{L}^{SET}), with regulating means (21, 29, 30) for generating a steering signal (δ_{L}) on the basis of the roll velocity signal (\dot{K}) and the set steering angle signal (δ_{L}^{set}), and with output means (31) for outputting the steering signal (δ_{L}) to a steering actuator (15) for steering one or more wheels (11) of at least one axle of the vehicle (10), characterized in that it activates the steering actuator (15) by means of the steering signal (δ_{L}) in such a way that, at least for a certain time, the vehicle (10) is kept in a single-track driving mode.

2. The tilt regulating device as claimed in claim 1, characterized in that, when a change of direction of the vehicle (10) into a first direction is prescribed by the set steering angle signal (δ_{L}^{SET}), the regulating means (21, 29, 30) activate the steering actuator (15) in a second direction, counter to the first direction.

3. The tilt regulating device as claimed in claim 1, characterized in that the detecting means (20) are designed for detecting a velocity signal (v), representing the velocity of the vehicle (10), and in that the regulating means (21, 29, 30) evaluate the velocity signal for the formation of the steering signal (δ_{L}).

4. The tilt regulating device as claimed in claim 1, characterized in that the detecting means (20) are designed for detecting a yaw angular velocity signal (\dot{ψ}), representing the yaw angular velocity of the vehicle (10), and in that the regulating means (21, 29, 30) evaluate the yaw angular velocity signal (\dot{ψ}) for the formation of the steering signal (δ_{L}).

5. The tilt regulating device as claimed in claim 1, characterized in that the detecting means (20) are designed for detecting a roll angle signal (κ), representing the roll angle of the vehicle (10), and in that the regulating means (21, 29, 30) evaluate the roll angle signal (κ) for the formation of the steering signal (δ_{L}).

6. The tilt regulating device as claimed in claim 1, characterized in that the detecting means (20) are designed for detecting a tire aligning torque signal (M_{R}), representing the tire aligning torque of the vehicle (10), and in that the regulating means (21, 29, 30) evaluate the tire aligning torque signal (M_{R}) for the formation of the steering signal (δ_{L}).

7. The tilt regulating device as claimed in claim 1, characterized in that the detecting means (20) are designed for detecting a lateral acceleration signal, representing the lateral acceleration of the vehicle (10), and/or a longitudinal acceleration signal, representing the longitudinal acceleration of the vehicle (10), and in that the regulating means (21, 29, 30) evaluate the lateral acceleration signal and/or the longitudinal acceleration signal for the formation of the steering signal (δ_{L}).

8. The tilt regulating device as claimed in claim 1, characterized in that the detecting means (20) are designed for detecting a lateral velocity signal (v_{q}), representing the lateral velocity of the vehicle (10), and/or a sideslip angle signal, representing the sideslip angle of the vehicle (10), and in that the regulating means (21, 29, 30) evaluate the lateral velocity signal (v_{q}) and/or the sideslip angle signal for the formation of the steering signal (δ_{L}).

9. The tilt regulating device as claimed in claim 1, characterized in that the regulating means (21, 29, 30) are designed for generating a steering reaction signal (M_{F}), and in that the output means are designed for outputting the steering reaction signal (M_{F}) to a steering reaction actuator (32) for the output of a steering reaction torque at a manual steering means (14) of the vehicle (10).

10. The tilt regulating device as claimed in claim 1, characterized in that the regulating means (21, 29, 30) are designed for determining a tilting state, required for the stabilization of the vehicle (10), in which the vehicle (10) is in a single-track driving mode.

11. The tilt regulating device as claimed in claim 1, characterized in that the regulating means (21, 29, 30) are assigned to a multi-track vehicle (10), and in that the the regulating means (21, 29, 30) keep the vehicle (10) in the tilting state until after the determination of an end of tilting signal.

12. The tilt regulating device as claimed in claim 1, characterized in that the regulating means (21, 29, 30) include a state observer (29).

13. The tilt regulating device as claimed in claim 1, characterized in that it has program code which can be executed by a control means, in particular a processor, of a stability control system of the vehicle (10).

14. A single-track or multi-track vehicle (10) with at least one tilt regulating device (16) as claimed in claim 1, with sensors for generating the roll velocity signal (\dot{κ}) and the set steering angle signal (δ_{L}^{SET}) and with a steering actuator (15), which can be activated by the tilt regulating device (16), for steering one or more wheels (15) of an axle of the vehicle (10).

15. A method for regulating the tilt of a vehicle (10), with the steps of:
detecting a roll velocity signal (\dot{κ}), representing the roll velocity of the vehicle (10),
detecting a set steering angle signal (δ_{L}^{SET}),
generating a steering signal (δ_{L}) on the basis of the roll velocity signal (κ) and the set steering angle signal (δ_{L}^{SET}), and
outputting the steering signal (δ_{L}) to a steering actuator (15) for steering one or more wheels (15) of at least one axle of the vehicle (10),
characterized in that the steering actuator (15) is activated by means of the steering signal (δ_{L}) in such a way that, at least for a certain time, the vehicle (10) is kept in a single-track driving mode.

16. The method as claimed in claim 15, characterized in that, to generate the steering signal (δ_{L}), a velocity signal (v), representing the velocity of the vehicle (10), and/or a yaw angular velocity signal (\dot{ψ}), representing the yaw angular velocity of the vehicle (10), and/or a roll angle signal (κ), representing the roll angle of the vehicle (10), and/or a tire aligning torque signal (M_{R}), representing the tire aligning torque of the vehicle (10), and/or a lateral acceleration signal, representing the lateral acceleration of the vehicle (10) and/or a longitudinal acceleration signal, representing the longitudinal acceleration of the vehicle (10), and/or a lateral velocity signal, representing the lateral velocity of the vehicle (10), and/or a sideslip angle signal, representing the sideslip angle of the vehicle (10), are evaluated.

17. The method as claimed in claim 16, characterized by the step of: generating and outputting a steering reaction signal to a steering reaction actuator for the output of a steering reaction torque at a manual steering means of the vehicle (10).

18. The method as claimed in claim 15, characterized by the step of: determining a tilting state, required for the stabilization of the vehicle (10), in which the vehicle (10) is in the single-track driving mode, and/or ending the tilting state after the reception of an end of tilting signal.

19. The method as claimed in claim 15, characterized by the step of: generating and outputting a steering reaction signal to a steering reaction actuator for the output of a steering reaction torque at a manual steering means of the vehicle (10).
